(19) United States
(12) Patent Application Publication
(10) Pub. No.: US 2010/0170422 A1
(43) Pub. Date: Jul. 8, 2010

(54) Custom concrete top for indoor/outdoor table and method of manufacture

(76) Inventors: Laurence Redmond, Jackson, NJ (US); Vincent J. Horvath, Manchester, NJ (US)

Correspondence Address: CHARLES I. BRODSKY, 2 BUCKS LANE, MARLBORO, NJ, 07746, US

(21) Appl. No.: 12/319,116

(22) Filed: Jan. 2, 2009

(51) Int. Cl. A47B 13/08; B29C 39/02; A47B 7/00

(52) U.S. Cl. 108/161; 156/245

(57) ABSTRACT

A concrete table top constructed from a composition of a concrete bonding agent, a powder concrete mix, a fiberglass particle mix and a marble dust mix provides strengthening against cracking for both indoors and outdoors use, and allows custom designing of its top surface with a painting or drawing as a work of art to be thereafter sealed as a display conversation piece beyond its mere utilitarian employment.

### CROSS-REFERENCE TO RELATED APPLICATIONS

None.

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

Not Applicable

### BACKGROUND OF THE INVENTION

1. Field of the Invention

This invention relates to concrete tables, in general, and to a custom concrete table top and its method of manufacture for indoor/outdoor use, in particular.

2. Description of the Related Art

Concrete table tops manufactured according to present methods experience cracking over time. Analysis and testing have shown that once cracks develop, not only does it detract from its appearance, but the techniques employed to fill in those cracks generally lead to a result where the seam becomes more noticeable. Being especially susceptible to this “cracking” when the table is used outdoors, those concrete tables manufactured today are primarily intended for indoor use. Where they have been employed outdoors, however, it has generally been for such simple items as barbecue pits and snack tables. Little effort has been spent to attempt to make them decorous as the ensuing cracks would glaringly show and mar the design.

### OBJECTS OF THE PRESENT INVENTION

It is an object of the present invention, therefore, to provide a new and improved concrete table top in which the possibility of its cracking is significantly reduced.

It is an object of the invention, also, to provide such a concrete table top which can be custom painted with pictures and drawings as a work of art in its own unique and decorative format, rather than just as a surface upon which tableware and glassware can be set.

It is another object of the invention to provide such a concrete table top which can be used both indoors and outdoors.

It is yet a further object of the invention to provide a concrete table top of this type of a weight reasonable enough so that it and its support base can be lifted and carried from the indoors to the outdoors, and vice versa, according to taste and to the requirements of the occasion of use.

### SUMMARY OF THE INVENTION

As will be clear from the following description, a custom concrete table top and its method of manufacture follow from its use of a composite material including a concrete bonding agent, a powder concrete mix, a fiberglass particle mix and a marble dust mix—supplemented as desired in adding further strength by a sheet of fiberglass mesh and by a fine particle sand mix. The displayed work of art is custom painted on the table top itself, and the table top is then coated with a water base sealer both on the underside of the table top and on the painting surface (preferably there with multiple coats). With the various ingredient components of the composition being each readily available, all that becomes necessary is their being mixed (or beat) together to a liquid consistency, and then appropriately smoothed in undergoing the ultimate transformation.

Specifically, a frame of appropriate size and shape is filled with the ingredient composition atop a smooth planar surface as the table top is being built up, with the table top then being inverted so that the custom painting can be on the side of the table top that original lay against the planar surface. In a preferred embodiment of the invention in manufacturing such concrete table top on an individualized basis, these ingredient components are all beat together to a liquid consistency in something just a simple as a 5 gallon bucket. Such bucket size has been found quite sufficient to form a concrete table top for a coffee table, for example, of a thickness of some 2 inches—yet, one weighing along with its supporting base legs only 50 pounds or so as to be easily moved about. A 25″×30″ concrete table top painted with a picture of one's favorite Sports Stadium, Landscape Scene, Animal Grouping, or any other arrangement could then be uniquely painted in providing not only a utilitarian table top able to withstand indoors and outdoors use without cracking for 10 years and more, but one which is indeed a customized unique and decorous conversation piece.

### BRIEF DESCRIPTION OF THE DRAWINGS

These and other features of the present invention will be more clearly understood from a consideration of the following description, taken in connection with the accompanying drawings, in which:

FIG. 1 is a flow chart illustrating a preferred method of manufacturing a custom concrete table top according to the invention;

FIG. 2 illustrates a table and concrete table top constructed according to the invention; and

FIG. 3 is a top view of a type of design that may be painted onto the table top and then made ready for years of use with one or more applications of a water-based sealer coat.

### DETAILED DESCRIPTION OF THE INVENTION

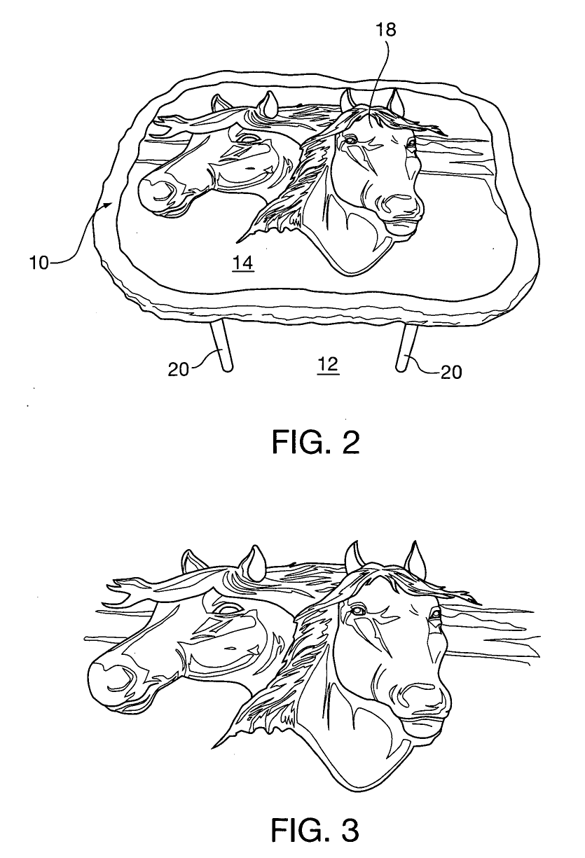

Referring to FIGS. 2 and 3 of the Drawings, a concrete table top portion 14 is supported by a bottom base portion 12 in forming a concrete table 10. The table top portion 14 is shown of a rounded-square configuration, on whose upper surface a customized, unique decorous painting 18 is made which, according to the invention, is preferably sealed with multiple coats of a water-based sealer. Such painting could be as simple or ornate as desired, as a picture of side-by-side Thorobreds. The base portion 12 may be in the form of legs 20 attachable to the top portion 14 by a concrete adhesive.

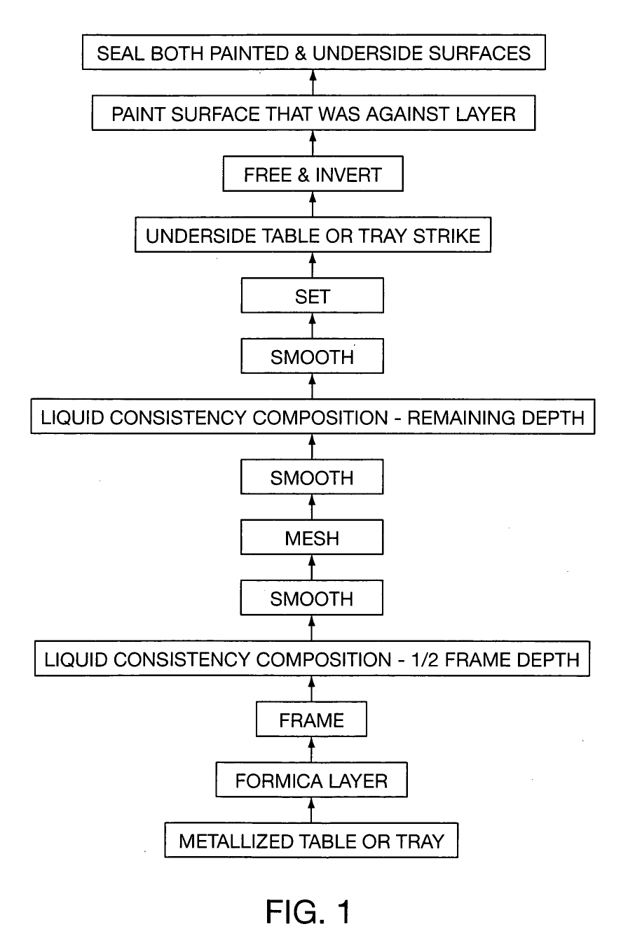

In accordance with the invention, a method of manufacturing the concrete table top for indoor/outdoor use as shown in FIG. 1 begins with filling a frame atop a smooth surface to a predetermined depth with a composition of a readily available concrete bonding agent, a powder concrete mix, a fiberglass particle mix, and a marble dust mix, all beat together to a liquid consistency. Such frame may, for example, be constructed of wood, set atop a layer of formica placed over a metallized table or tray for a manufacture of a concrete table top on a piece-by-piece basis. The beating, or mixing of the ingredients to this liquid consistency can all be carried out within a simple 5 gallon bucket, with or without the concrete bonding agent first being cut with added water to reach the consistency desired. Once poured into the frame—and preferably to one-half the depth of the frame (for example, to a depth of 1″, of a 2″ frame)—, the top surface of the composition is then smoothed flat as with a trowel. Once set, the underside of the metallized tray is struck, as with a hammer, to release any air entrapped within the composition, and the top surface of the composition is then smoothed again. The frame is then cut away, or the composition eased from the frame through the use of a putty knife, and the composition is then inverted on the formica layer. Allowing the composition to then set overnight, the surface of the composition that was originally against the smooth formica layer is then ready for the customized painting and the sealing to follow. Where desired, to further strengthen the concrete table top which results, the ingredient composition could also include a mix of fine sand particles.

Whereas the foregoing description proceeded with filling the frame only one-half its depth, and the table top which results affords the advantages outlined above, the manufacture according to the present invention also preferably includes the additional step of adding a sheet of fiberglass mesh onto the top surface of the composition before the underside of the metal table is struck. Such sheet of fiberglass mesh would then be smoothed into the top surface of the composition, and the remaining depth of the frame could be filled towards completion by overlaying the sheet of fiberglass mesh with a second like composition of the various ingredient components—in effect, the remaining bucket mix. Once that is accomplished, the upper surface of the composition is smoothed once more, prior to the underside striking of the metallized tray.

As will be appreciated, freeing the composition from the frame and then inverting it onto the work tray presents the surface of the composition that was originally against the formica layer as the smooth surface of the concrete table top to be painted in providing the work of art desired. Once done, the painting is then coated with one, two, three or preferably 4-5 layers of a water based sealer.

Testing has shown that using the marble dust mix, the fiberglass particle mix and the fiberglass sheet mesh in this manner provides a much greater strength to the concrete table top so as to greatly reduce any tendency for it to crack. Their use in this manner also allows the table top, once painted, to maintain its beauty and appearance, as there becomes obviated any of the seam cracks that would otherwise develop over time to mar its appearance. A table top centerpiece effectively results, available for both indoors and outdoors use and is movable from place to place. Realizing from the above description how unique the display appearance would be over and above the strength that is added to the concrete table top, it will also become apparent that the table top display can also be interchangeable with any other comparable display merely by loosening, or otherwise freeing the table top from the base bottom portion or legs which support it. Mixing the ingredients to provide the liquid consistency needed in filling the frame can simply be had through the employment of an electric drill with a paint beater attachment—altogether taking just a few moments to reach the consistency at which the composite mix can then be poured into the frame in allowing the various smoothing to be done simply with a hand trowel.

While there have been described what are considered to be preferred embodiments of the invention, it will be readily appreciated by those skilled in the art that the custom concrete table top and the method of its manufacture according to the invention may be modified without departing from the scope of the teachings herein. For at least such reason, therefore, resort should be had to the claims appended hereto for a true understanding of the scope of the invention.

We claim:

1. A method of manufacturing atop a planar smooth surface over a metallized tray a table top for indoor/outdoor use comprising the steps of:
first, filling a frame on the surface to -a predetermined depth with a composition of a concrete bonding agent, a powder concrete mix, a fiberglass particle mix and a marble dust mix, all beat together to a liquid consistency;
second, smoothing the top surface of the composition;
third, striking an underside of the metallized tray to release entrapped air bubbles from the composition;
fourth, smoothing the top surface of the composition s second time;
fifth, allowing the composition to set;
sixth, freeing the composition from the frame;
seventh, inverting the freed composition; and
eighth, sealing the surface of the set composition that originally formed against the planar smooth surface.

2. The method of claim 1, wherein between the second and third steps, there is additionally included the step of adding a sheet of fiberglass mesh onto the top surface of the composition.

3. The method of claim 2 wherein said sheet of fiberglass mesh is smoothed onto the top surface of the composition.

4. The method of claim 3 wherein said sheet of fiberglass mesh is then covered over with a second composition of the concrete bonding agent, the powder concrete mix, the fiberglass particle mix and the marble dust mix, also beat together to a liquid consistency.

5. The method of claim 4 wherein the top surface of said second composition is smoothed prior to the underside striking of the metallized tray of said third step.

6. The method of claim 1, wherein between the seventh and eighth steps, there is also included the step of custom designing a picture or drawing as a work of art onto the surface of the set composition that was originally formed atop the planar smooth surface.

7. The method of claim 6 wherein said composition also includes a fine particle sand mix.

8. The method of claim 6 wherein said eighth step applies multiple coats of a water based sealer on top of the custom designed work of art.

9. The method of claim 8, also including a ninth step of coating the opposite surface of the set composition with a water based sealer after its freeing from the frame.

10. The method of claim 5 wherein said first step fills the frame with said first composition to substantially ½ its depth and wherein said second composition fills said frame to its full depth.

11. The method of claim 10 wherein said first step fills the frame with said first composition to a depth of 1 inch and wherein said second composition fills said frame to a depth of 2 inches.

12. The method of claim 10 wherein each of said first and second compositions includes a fine particle sand mix.

13. A concrete table for indoor/outdoor use comprising:
a top table portion; and
a bottom base portion coupled to support said top, table portion; and
wherein said top table portion is composed of a concrete bonding agent, a powder concrete mix, a fiberglass particle mix and a marble dust mix, all beat together to a liquid consistency and allowed to set.

14. The concrete table of claim 13 wherein said top table portion composition also includes a fine particle sand mix.

15. The concrete table of claim 13 wherein said top table portion also includes a sheet of fiberglass mesh smoothed into the top surface of the table top composition.

16. The concrete table of claim 13 including a custom designed picture or drawing as a work of art on the top surface of said table top composition.

17. The concrete table of claim 16 additionally including a water based sealer coating the custom designed work of art.

18. The concrete table of claim 17 further including a water based sealer coating the underside surface of the table top composition.

19. The concrete table of claim 13 wherein said top table portion also includes a sheet of fiberglass mesh smoothed into the top surface of the table top composition and including a custom designed picture or drawing as a work of art on the top surface of said table top composition and a water based sealer coating the custom designed work of art.

20. The concrete table of claim 19 wherein said top table portion composition also includes a fine particle sand mix and further including a water based sealer coating the custom designed work of art.
